(19) United States
(12) Patent Application Publication
(10) Pub. No.: US 2024/0151341 A1
(43) Pub. Date: May 9, 2024

(54) PIPE RESTRAINT SYSTEMS

(71) Applicant: Romac Industries, Inc., Bothell, WA (US)

(72) Inventor: Andrew Michael Lemke, Bothell, WA (US)

(21) Appl. No.: 18/503,818

(22) Filed: Nov. 7, 2023

Related U.S. Application Data
(60) Provisional application No. 63/382,864, filed on Nov. 8, 2022.

(51) Int. Cl. F16L 55/115

(52) U.S. Cl. CPC F16L 55/1157

(57) ABSTRACT

A system comprises an annular gasket, a grip ring assembly including a plurality of distinct grip ring segments separated from one another by slots that interrupt an otherwise annular shape of the grip ring assembly, a spacer that fills the slots, couples the grip ring segments to one another, and maintains alignment of the grip ring segments, a radially-innermost surface having circumferential pipe-gripping teeth, and a radially-outermost surface, wherein the spacer has an elastic modulus configured to improve engagement of the annular gasket with a radially-outward facing surface of a pipe prior to the pipe-gripping teeth biting into the radially-outward facing surface of the pipe when the grip ring assembly is deformed such that sizes of the slots decrease, and an annular gland including an inner surface that faces toward the radially-outermost surface of the grip ring assembly.

### BACKGROUND

### Technical Field

The present disclosure relates generally to pipe restraint systems, which may be used to rigidly couple components to an end of a pipe.

### Description of the Related Art

Various technologies exist for coupling components to ends of pipes. For example, U.S. Pat. Nos. 5,335,946 and 5,803,513 describe technologies for coupling components to ends of pipes. Nevertheless, there is room for improvement in such technologies.

### BRIEF SUMMARY

A system may be summarized as comprising: an annular gasket; a grip ring including: a slot that interrupts an otherwise annular shape of the grip ring such that the grip ring has a first end adjacent a first side of the slot and a second end adjacent a second side of the slot opposite to the first side of the slot; a radially-innermost surface having circumferential pipe-gripping teeth; a radially-outermost surface; a first end surface that extends radially inward from the radially-outermost surface to the radially-innermost surface and that faces toward the annular gasket; and a second end surface that extends radially inward from the radially-outermost surface to the radially-innermost surface and that faces away from the annular gasket; wherein a cross-sectional area of the grip ring increases from a first local minimum at the first end of the grip ring to a maximum at a location between the first end of the grip ring and the second end of the grip ring along the annular shape of the grip ring and from a second local minimum at the second end of the grip ring to the maximum at the location between the first end of the grip ring and the second end of the grip ring along the annular shape of the grip ring; and an annular gland including an inner surface that faces toward the radially-outermost surface of the grip ring.

The cross-sectional area of the grip ring may increase continuously from the first local minimum to the maximum and from the second local minimum to the maximum. The cross-sectional area of the grip ring may increase in steps from the first local minimum to the maximum and from the second local minimum to the maximum. The increasing of the cross-sectional area of the grip ring may increase uniformity of deformations in the grip ring when the grip ring is deformed such that the first end of the grip ring moves toward the second end of the grip ring. The increasing of the cross-sectional area of the grip ring may increase a roundness of the grip ring when the grip ring is deformed such that the first end of the grip ring moves toward the second end of the grip ring.

When the grip ring is deformed such that the first end of the grip ring moves toward the second end of the grip ring, the increasing of the cross-sectional area of the grip ring may increase a degree of compression of the annular gasket prior to the pipe-gripping teeth biting into a surface of a pipe, thereby improving engagement of the annular gasket with the surface of the pipe. When the grip ring is deformed such that the first end of the grip ring moves toward the second end of the grip ring, the increasing of the cross-sectional area of the grip ring may increase a uniformity of compression of the annular gasket prior to the pipe-gripping teeth biting into a surface of a pipe, thereby improving engagement of the annular gasket with the surface of the pipe.

The first end surface of the grip ring may directly contact the gasket. The first end surface of the grip ring may be larger than the second end surface of the grip ring. The inner surface of the gland may directly contact the radially-outermost surface of the grip ring. A cross-sectional shape of the grip ring may be convex at the radially-outermost surface of the grip ring and a cross-sectional shape of the annular gland may be concave at the inner surface of the annular gland. The radially-outermost surface of the grip ring may form at least a portion of a surface of a ball of a ball-and-socket joint and the inner surface of the annular gland may form at least a portion of a surface of a socket of the ball-and-socket joint. A cross-sectional shape of the grip ring may be concave at the radially-outermost surface of the grip ring and a cross-sectional shape of the annular gland may be convex at the inner surface of the annular gland. The radially-outermost surface of the grip ring may form at least a portion of a surface of a socket of a ball-and-socket joint and the inner surface of the annular gland may form at least a portion of a surface of a ball of the ball-and-socket joint. A cross-sectional shape of the grip ring may have a curved edge at the radially-outermost surface of the grip ring and a cross-sectional shape of the annular gland may have a curved edge at the inner surface of the annular gland. The system may further comprise a spacer ring between the annular gasket and the grip ring.

A system may be summarized as comprising: an annular gasket; a grip ring assembly including: a plurality of distinct grip ring segments separated from one another by slots that interrupt an otherwise annular shape of the grip ring assembly; a spacer that fills the slots, couples the grip ring segments to one another, and maintains alignment of the grip ring segments; a radially-innermost surface having circumferential pipe-gripping teeth; a radially-outermost surface; a first end surface that extends radially inward from the radially-outermost surface to the radially-innermost surface and that faces toward the annular gasket; and a second end surface that extends radially inward from the radially-outermost surface to the radially-innermost surface and that faces away from the annular gasket; wherein the spacer has an elastic modulus configured to improve engagement of the annular gasket with a radially-outward facing surface of a pipe prior to the pipe-gripping teeth biting into the radially-outward facing surface of the pipe when the grip ring assembly is deformed such that sizes of the slots decrease; and an annular gland including an inner surface that faces toward the radially-outermost surface of the grip ring assembly.

The spacer may be an elastomeric spacer. The spacer may be a metallic spacer. When the grip ring assembly is deformed such that the sizes of the slots decrease, the spacer may undergo only elastic deformation. When the grip ring assembly is deformed such that sizes of the slots decrease, the spacer may undergo plastic deformation. When the grip ring assembly is deformed such that sizes of the slots decrease, the elastic modulus of the spacer may control a degree of compression of the annular gasket prior to the pipe-gripping teeth biting into the radially-outward facing surface of the pipe. When the grip ring assembly is deformed such that sizes of the slots decrease, the grip ring segments may move toward one another and the grip ring segments may increase a degree of compression of the annular gasket prior to the pipe-gripping teeth biting into the radially-outward facing surface of the pipe, thereby improving engagement of the annular gasket with the radially-outward facing surface of the pipe.

The pipe-gripping teeth may be integral with the plurality of distinct grip ring segments. The pipe-gripping teeth may be not integral with the plurality of distinct grip ring segments. The pipe may be a first pipe and the annular gasket may be engaged with the radially-outward facing surface of the first pipe and with an at least partially longitudinally-facing surface of a second pipe to create a seal between the first pipe and the second pipe at a joint between the first and second pipes. The second pipe may be a component of a pipe fitting. The second pipe may be a component of a pipe valve. The pipe-gripping teeth may engage the radially-outward facing surface of the first pipe to resist longitudinal movement of the first pipe with respect to the grip ring assembly. The engagement of the pipe-gripping teeth with the radially-outward facing surface of the first pipe can be released by a human operator without further damaging the first pipe or the second pipe. The distinct grip ring segments may be accessible by a human operator from outside the joint. When the annular gland is removed from the joint between the first pipe and the second pipe, the pipe-gripping teeth may disengage from the radially-outward facing surface of the first pipe and cease resisting longitudinal movement of the first pipe with respect to the grip ring assembly.

A cross-sectional shape of each of the distinct grip ring segments of the grip ring assembly may be convex at a radially-outermost surface of the grip ring segment and a cross-sectional shape of the annular gland may be concave at the inner surface of the annular gland. A radially-outermost surface of each of the distinct grip ring segments may form at least a portion of a surface of a ball of a ball-and-socket joint and the inner surface of the annular gland may form at least a portion of a surface of a socket of the ball-and-socket joint. A cross-sectional shape of each of the distinct grip ring segments may be concave at a radially-outermost surface of the grip ring segment and a cross-sectional shape of the annular gland may be convex at the inner surface of the annular gland. A radially-outermost surface of each of the distinct grip ring segments may form at least a portion of a surface of a socket of a ball-and-socket joint and the inner surface of the annular gland may form at least a portion of a surface of a ball of the ball-and-socket joint. A cross-sectional shape of each of the distinct grip ring segments may have a curved edge at a radially-outermost surface of the grip ring segment and a cross-sectional shape of the annular gland may have a curved edge at the inner surface of the annular gland. The system may further comprise a spacer ring between the annular gasket and the grip ring.

A kit of plural pipe joint systems may be summarized as comprising: a first pipe joint system, including: a first annular gasket; a first grip ring including: a slot that interrupts an otherwise annular shape of the first grip ring such that the first grip ring has a first end adjacent a first side of the slot and a second end adjacent a second side of the slot opposite to the first side of the slot, the annular shape having a first inner diameter and a first cross-sectional profile; a radially-innermost surface having circumferential pipe-gripping teeth; a radially-outermost surface; a first end surface that extends radially inward from the radially-outermost surface to the radially-innermost surface and that faces toward the first annular gasket; and a second end surface that extends radially inward from the radially-outermost surface to the radially-innermost surface and that faces away from the first annular gasket; and a first annular gland including an inner surface that faces toward the radially-outermost surface of the first grip ring; and a second pipe joint system, including: a second annular gasket; a second grip ring including: a slot that interrupts an otherwise annular shape of the second grip ring such that the second grip ring has a first end adjacent a first side of the slot and a second end adjacent a second side of the slot opposite to the first side of the slot, the annular shape having a second inner diameter larger than the first inner diameter and a second cross-sectional profile, where the second cross-sectional profile is larger than the first cross-sectional profile; a radially-innermost surface having circumferential pipe-gripping teeth; a radially-outermost surface; a first end surface that extends radially inward from the radially-outermost surface to the radially-innermost surface and that faces toward the second annular gasket; and a second end surface that extends radially inward from the radially-outermost surface to the radially-innermost surface and that faces away from the second annular gasket; and a second annular gland including an inner surface that faces toward the radially-outermost surface of the second grip ring.

A cross-sectional area of the first grip ring at the first end of the first grip ring may be smaller than a cross-sectional area of the second grip ring at the first end of the second grip ring; a cross-sectional area of the first grip ring at the second end of the first grip ring may be smaller than a cross-sectional area of the second grip ring at the second end of the second grip ring; and a cross-sectional area of the first grip ring at a mid-point of the first grip ring may be smaller than a cross-sectional area of the second grip ring at a mid-point of the second grip ring. The first and second cross-sectional profiles of the first and second grip rings may be configured to ensure that behavior of the first grip ring when the first grip ring is deformed such that the first end of the first grip ring moves toward the second end of the first grip ring matches behavior of the second grip ring when the second grip ring is deformed such that the first end of the second grip ring moves toward the second end of the second grip ring. The first cross-sectional profile may have a first overall length in a direction parallel to a central longitudinal axis of the first pipe joint system and the second cross-sectional profile may have a second overall length in a direction parallel to a central longitudinal axis of the second pipe joint system that is larger than the first overall length.

A kit of plural pipe joint systems may be summarized as comprising: a first pipe joint system, including: a first annular gasket; a first grip ring including: a slot that interrupts an otherwise annular shape of the first grip ring such that the first grip ring has a first end adjacent a first side of the slot and a second end adjacent a second side of the slot opposite to the first side of the slot, the annular shape having a first inner diameter; a radially-innermost surface having circumferential pipe-gripping teeth; a radially-outermost surface that extends at a first oblique angle to the radially-innermost surface; a first end surface that extends radially inward from the radially-outermost surface to the radially-innermost surface and that faces toward the first annular gasket; and a second end surface that extends radially inward from the radially-outermost surface to the radially-innermost surface and that faces away from the first annular gasket; and a first annular gland including an inner surface that faces toward the radially-outermost surface of the first grip ring; and a second pipe joint system, including: a second annular gasket; a second grip ring including: a slot that interrupts an otherwise annular shape of the second grip ring such that the second grip ring has a first end adjacent a first side of the slot and a second end adjacent a second side of the slot opposite to the first side of the slot, the annular shape having a second inner diameter larger than the first inner diameter; a radially-innermost surface having circumferential pipe-gripping teeth; a radially-outermost surface that extends at a second oblique angle to the radially-innermost surface, wherein the second oblique angle is different than the first oblique angle; a first end surface that extends radially inward from the radially-outermost surface to the radially-innermost surface and that faces toward the second annular gasket; and a second end surface that extends radially inward from the radially-outermost surface to the radially-innermost surface and that faces away from the second annular gasket; and a second annular gland including an inner surface that faces toward the radially-outermost surface of the second grip ring.

The first and second oblique angles may be configured to ensure that behavior of the first grip ring when the first grip ring is deformed such that the first end of the first grip ring moves toward the second end of the first grip ring matches behavior of the second grip ring when the second grip ring is deformed such that the first end of the second grip ring moves toward the second end of the second grip ring.

A system may be summarized as comprising: an annular gasket; a grip ring including: a radially-innermost surface having circumferential pipe-gripping teeth; a radially-outermost surface; a first end surface that extends radially inward from the radially-outermost surface to the radially-innermost surface and that faces toward the annular gasket; and a second end surface that extends radially inward from the radially-outermost surface to the radially-innermost surface and that faces away from the annular gasket; wherein a cross-sectional shape of the grip ring is convex at the radially-outermost surface of the grip ring; and an annular gland including an inner surface that faces toward the radially-outermost surface of the grip ring.

A cross-sectional shape of the annular gland may be concave at the inner surface of the annular gland. A cross-sectional shape of the annular gland may be linear at the inner surface of the annular gland. The radially-outermost surface of the grip ring may form at least a portion of a surface of a ball of a ball-and-socket joint and the inner surface of the annular gland may form at least a portion of a surface of a socket of the ball-and-socket joint.

A system may be summarized as comprising: an annular gasket; a grip ring including: a radially-innermost surface having circumferential pipe-gripping teeth; a radially-outermost surface; a first end surface that extends radially inward from the radially-outermost surface to the radially-innermost surface and that faces toward the annular gasket; and a second end surface that extends radially inward from the radially-outermost surface to the radially-innermost surface and that faces away from the annular gasket; and an annular gland including an inner surface that faces toward the radially-outermost surface of the grip ring; wherein a cross-sectional shape of the annular gland is convex at the inner surface of the annular gland.

A cross-sectional shape of the grip ring may be concave at the radially-outermost surface of the grip ring. A cross-sectional shape of the grip ring may be linear at the radially-outermost surface of the grip ring. The radially-outermost surface of the grip ring may form at least a portion of a surface of a socket of a ball-and-socket joint and the inner surface of the annular gland may form at least a portion of a surface of a ball of the ball-and-socket joint.

### BRIEF DESCRIPTION OF THE SEVERAL VIEWS OF THE DRAWINGS

FIG. 1 illustrates a perspective view of a system for capping an end of a pipe.

FIG. 2 illustrates a different perspective view of the system for capping an end of a pipe illustrated in FIG. 1, applied to the end of a pipe.

FIG. 3 illustrates a perspective view of an end cap portion of the system of FIGS. 1 and 2 and the pipe of FIG. 2.

FIG. 4 illustrates a perspective view of a gland component of the system of FIGS. 1 and 2.

FIG. 5 illustrates a perspective view of a grip ring component of the system of FIGS. 1 and 2.

FIG. 6 illustrates a perspective view of a gasket component of the system of FIGS. 1 and 2.

FIG. 7 illustrates a cross-sectional view of the system of FIGS. 1 and 2 and the pipe of FIG. 3 with the system in a released configuration.

FIG. 8 illustrates a cross-sectional view of the system of FIGS. 1 and 2 and the pipe of FIG. 3 with the system in an engaged configuration.

FIG. 9A illustrates an end view of the grip ring component of FIG. 5.

FIG. 9B illustrates a cross-sectional view of the grip ring component of FIGS. 5 and 9A.

FIG. 10 illustrates an exploded view of another embodiment of a system for capping an end of a pipe.

FIG. 11A illustrates a cross-sectional view of the system of FIG. 10 with the system in a released configuration.

FIG. 11B illustrates a portion of FIG. 11A at a larger scale.

FIG. 12A illustrates a cross-sectional view of the system of FIG. 10 with the system in an engaged configuration.

FIG. 12B illustrates a portion of FIG. 12A at a larger scale.

FIG. 13 illustrates an exploded view of another embodiment of a system for capping an end of a pipe.

FIGS. 14A-14F illustrate various views of a grip ring segment of the system of FIG. 13.

FIG. 15 illustrates a cross-sectional view of the system of FIG. 13 with the system in a released configuration.

FIG. 16 illustrates a cross-sectional view of the system of FIG. 13 with the system in an engaged configuration.

FIG. 17 illustrates a portion of an end view of the system of FIG. 13.

FIG. 18 illustrates an exploded view of another embodiment of a system for capping an end of a pipe.

FIG. 19 illustrates a perspective view of a grip ring assembly of the system of FIG. 18.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with the technology have not been shown or described in detail to avoid unnecessarily obscuring descriptions of the implementations.

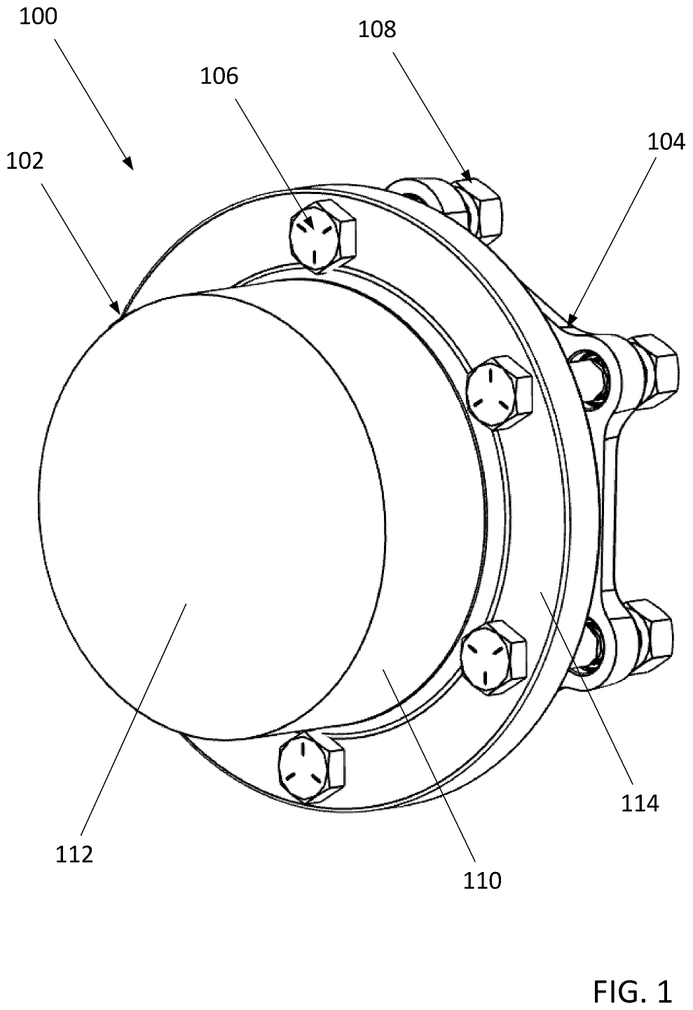

FIG. 1 illustrates a system 100 for capping an end of a pipe. As illustrated in FIG. 1, the system 100 includes an end cap 102, a gland 104, and a plurality of bolts 106 and respective nuts 108 that couple the end cap 102 to the gland 104. The end cap 102 includes a hollow cylindrical body 110 that is closed at a first end 112 and open at a second end opposite to the first end 112 along a central longitudinal axis of the hollow cylindrical body 110. The end cap 102 also includes a flange 114 that extends radially outward from the open second end of the hollow cylindrical body 110. The bolts 106 are spaced equidistantly apart from one another circumferentially around the flange 114. In the embodiment illustrated in FIG. 1, the system 100 includes six bolts 106 and six respective nuts 108, but in alternative embodiments, the system 100 may include any number (e.g., three, four, five, eight, ten, twelve, etc.) of bolts 106 and respective nuts 108. Each of the bolts 106 extends through the flange 114 and through the gland 104, as well as through a respective one of the nuts 108, along a respective axis parallel to the central longitudinal axis of the hollow cylindrical body 110, such that the end cap 102 and gland 104 are secured adjacent to one another by the bolts 106 and nuts 108.

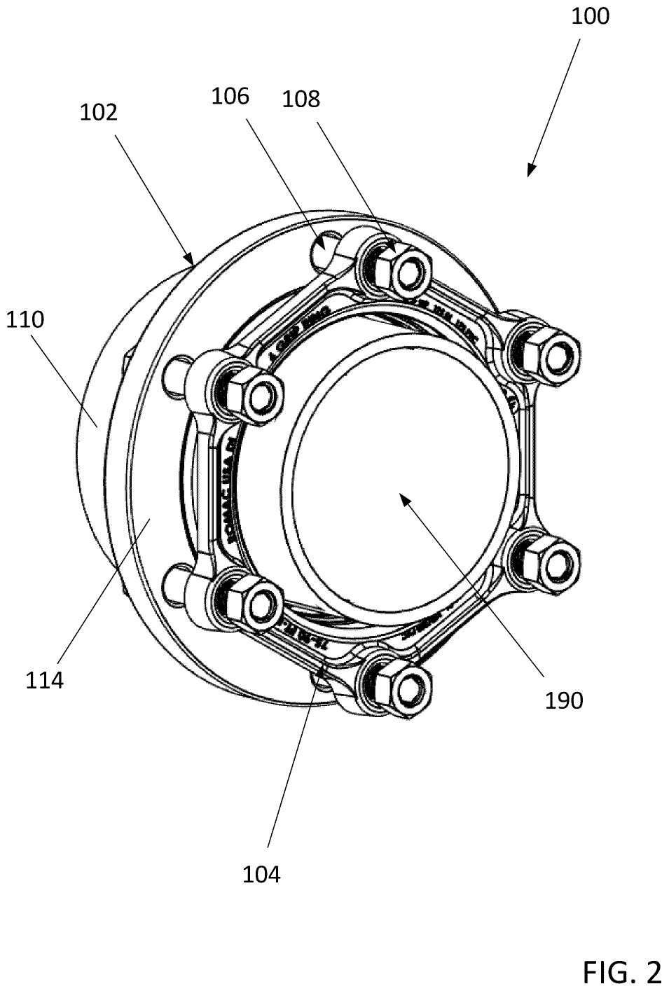

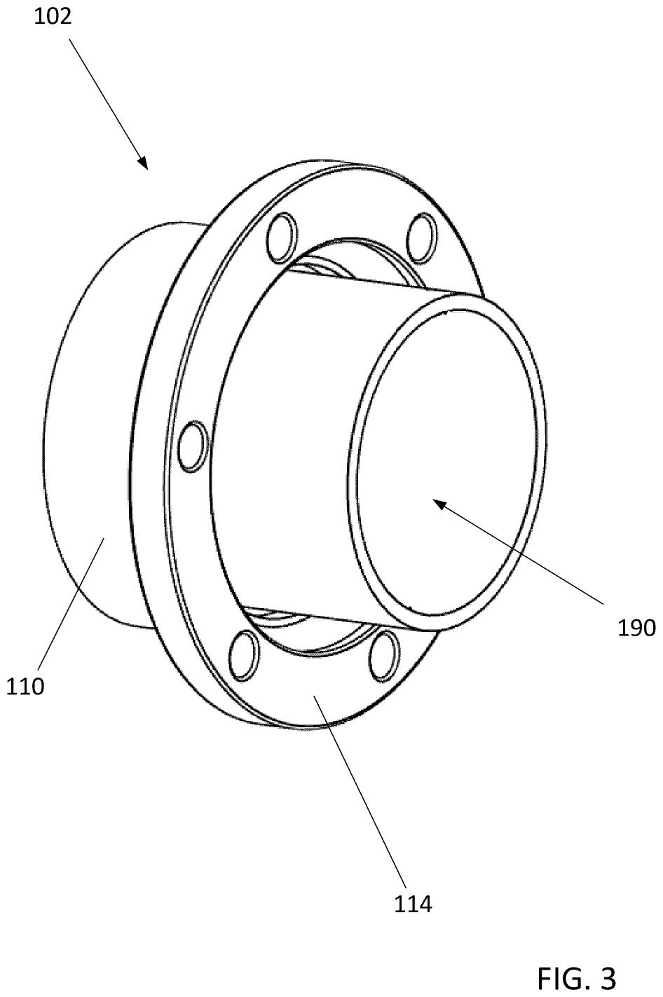

In use, the system 100 can be applied to the end of a pipe and the nuts 108 can be threaded onto the bolts 106 to secure the system 100 to the end of the pipe, as described in further detail elsewhere herein. During such a process, threading the nuts 108 further onto the bolts 106 can force, urge, and/or bias the gland 104 toward the flange 114 of the end cap 102, and further actuate other components of the system 100 to secure the system 100 to the pipe. FIG. 2 illustrates a different perspective view of the system 100, including the end cap 102 and the gland 104, applied to an end of a pipe 190. An inner diameter of the hollow cylindrical body 110 is larger than an outer diameter of the pipe 190, so that an end portion of the pipe 190 can be inserted into the hollow cylindrical body 110 of the system 100. Similarly, an inner diameter of the gland 104 is larger than an outer diameter of the pipe 190, so that an end portion of the pipe 190 can be inserted through the gland 104. FIG. 3 illustrates the end cap 102 and the pipe 190 by themselves, with the rest of the system 100 removed, to more clearly illustrate those components. FIG. 4 illustrates the gland 104 by itself, with the rest of the system 100 and the pipe 190 removed, to more clearly that component.

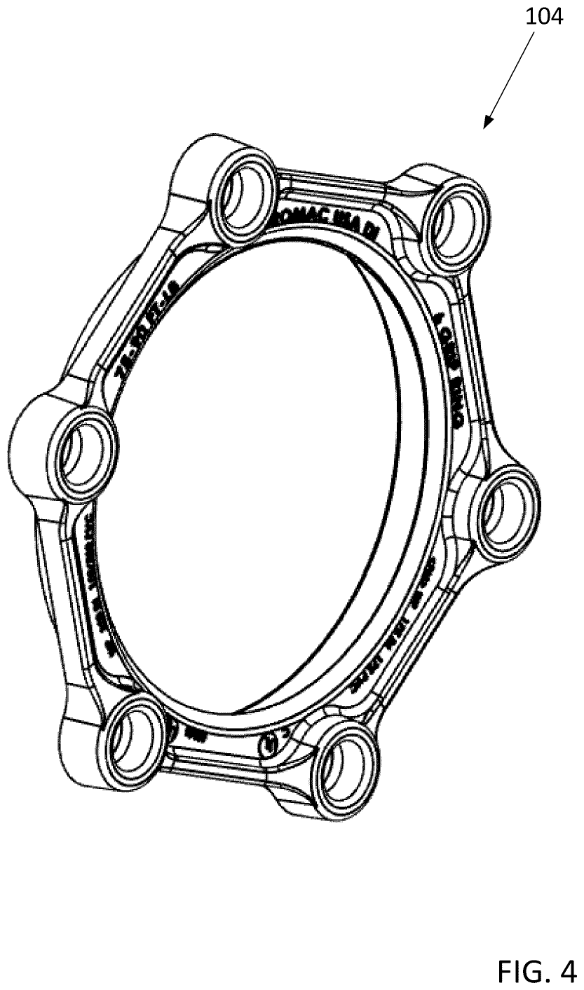

FIG. 5 illustrates a grip ring 116 of the system 100 isolated from the rest of the components of the system 100. As illustrated in FIG. 5, the grip ring 116 has an overall ring, hoop, or annular shape, where such shape is interrupted by a slot 118. An inner diameter of the grip ring 116 is larger than an outer diameter of the pipe 190, so that an end portion of the pipe 190 can be inserted through the grip ring 116. Further, a radially innermost surface 120 of the grip ring 116 has a plurality of gripping teeth configured to grip or bite into an outer surface of the pipe 190 to secure the system 100 to the pipe 190. FIG. 6 illustrates a gasket 122 of the system 100 isolated from the rest of the components of the system 100. As illustrated in FIG. 6, the gasket 122 has an overall ring, hoop, or annular shape, where such shape is not interrupted by a slot. The gasket 122 may be made of a rubber, elastomer, and/or elastomeric material, such as a styrene-butadiene rubber (SBR) material. An inner diameter of the gasket 122 is larger than an outer diameter of the pipe 190, so that an end portion of the pipe 190 can be inserted through the gasket 122. The gasket 122 is configured to create a seal against the outer surface of the pipe 190 to seal the system 100 to the pipe 190.

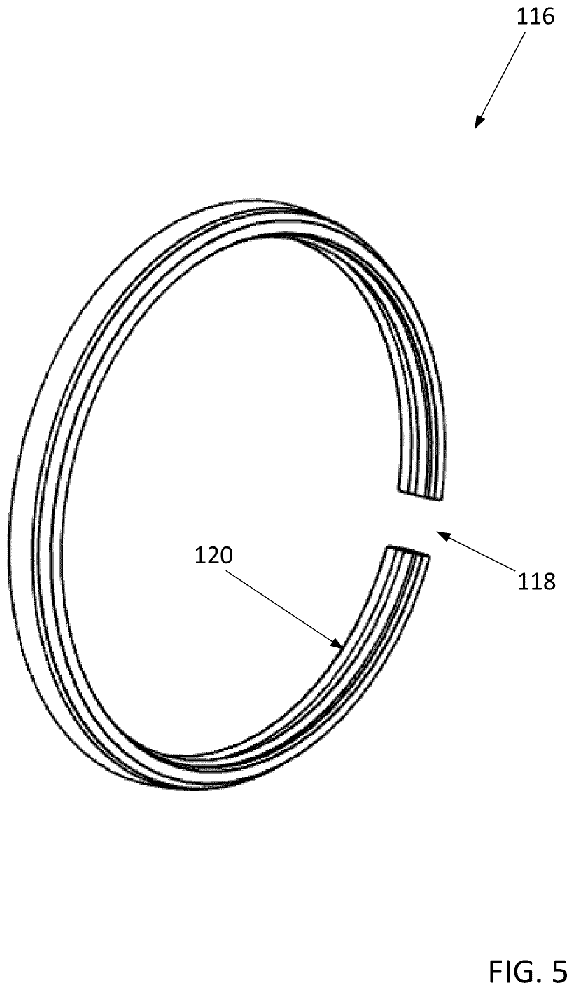

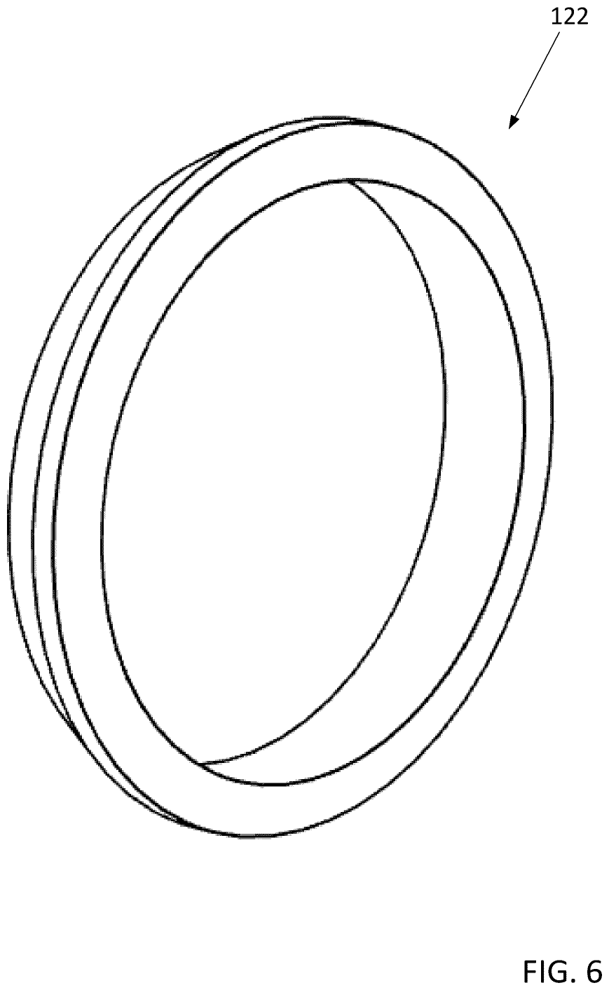

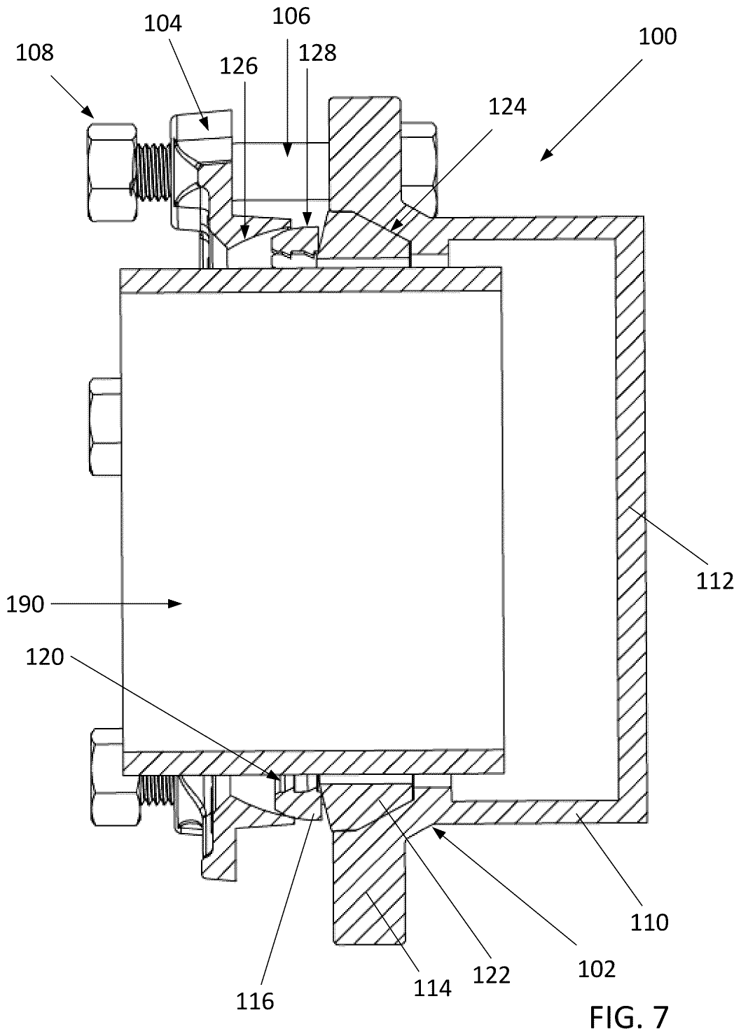

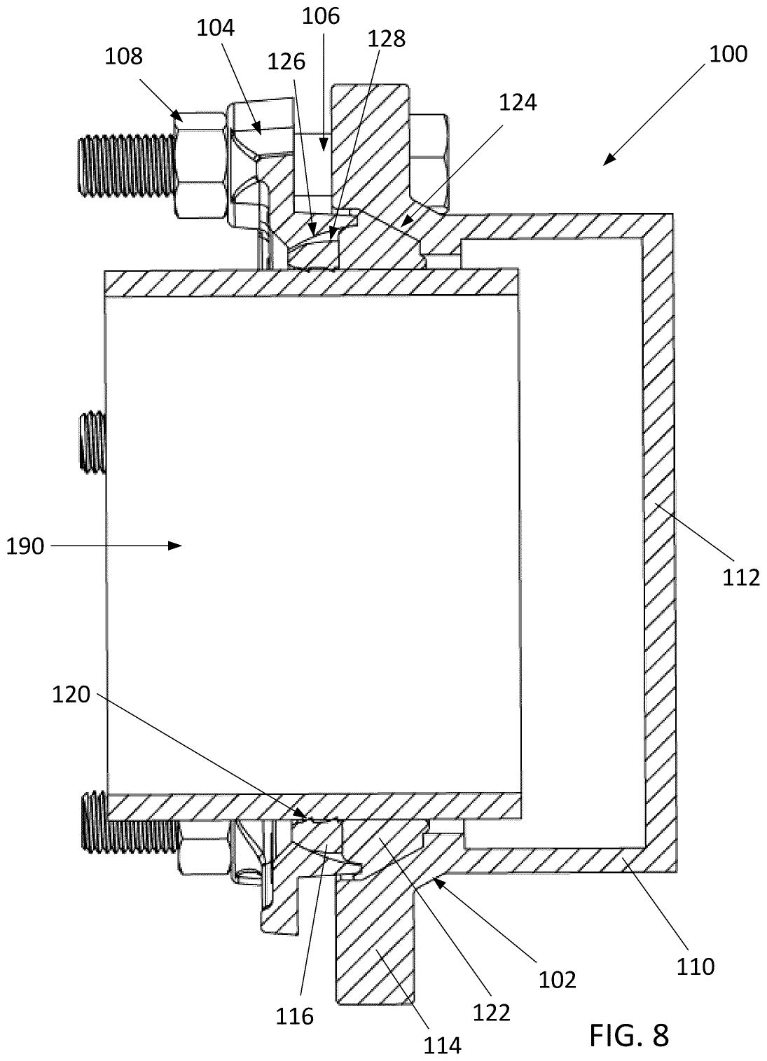

FIG. 7 illustrates a cross-sectional view of the system 100 and the pipe 190 when the system 100 is in a released configuration, and FIG. 8 illustrates a cross-sectional view of the system 100 and the pipe 190 when the system 100 is in an engaged configuration. Together, FIGS. 7 and 8 illustrate what happens to the system 100 when the nuts 108 are threaded onto and tightened on the bolts 106 to actuate other components of the system 100 and secure the system 100 to the pipe 190. In particular, as illustrated in FIGS. 7 and 8, the end cap 102 and the pipe 190 remain stationary with respect to one another as the nuts 108 are threaded onto the bolts 106. As the nuts 108 are threaded onto the bolts 106, the nuts 108 travel toward the heads of the bolts 106, toward the gland 104, and toward the flange 114 of the end cap 102. Once the nuts 108 directly physically engage with the gland 104, continued threading of the nuts 108 onto the bolts 106 forces the gland 104 to move axially toward the flange 114 of the end cap 102.

As shown in FIGS. 7 and 8, an inner surface 124 of the end cap 102 directly radially inward of the flange 114 and at the second end of the hollow cylindrical body 110 is sloped or conical. Specifically, as the inner surface 124 extends axially or longitudinally toward the second end of the hollow cylindrical body 110, it also extends radially outward, such that the inner diameter of the end cap 102 increases in a direction toward the second end of the hollow cylindrical body 110. Similarly, an inner surface 126 of the gland 104 is sloped, conical, or substantially conical. Specifically, as the inner surface 126 extends axially or longitudinally toward the end cap 102, it also extends radially outward, such that the inner diameter of the gland 104 increases in a direction toward the end cap 102. Even more specifically, while the inner surface 126 of the gland 104 may be substantially conical, it may also be curved, and may have either a convex curvature or a concave curvature (as shown in FIGS. 7 and 8). In some embodiments, the curved surfaces may have a radius of curvature of 2.2 inches.

As illustrated in FIGS. 7 and 8, the grip ring 116 may be located directly radially inward of the gland 104, such that an outer surface of the grip ring 116 is directly physically engaged with the inner surface 126 of the gland 104. As further illustrated in FIGS. 7 and 8, an outer surface 128 of the grip ring 116 is sloped, conical, or substantially conical. Specifically, as the outer surface 128 extends axially or longitudinally toward the end cap 102, it also extends radially outward, such that the outer diameter of the grip ring 116 increases in a direction toward the end cap 102. Even more specifically, while the outer surface 128 of the grip ring 116 may be substantially conical, it may also be curved, and may have either a convex curvature (as shown in FIGS. 7 and 8) or a concave curvature. In some embodiments, the curved surfaces may have a radius of curvature of 2.2 inches. A sloped, substantially conical, and/or curved profile of the outer surface 128 of the grip ring 116 may match, correspond to, and/or be the same as a sloped, substantially conical, and/or curved profile of the inner surface 124 of the end cap 102, such that these two surfaces can engage with one another and lie flush against one another.

In embodiments where these two surfaces are curved, they may form at least a portion of a ball and socket joint, such that, when the system 100 is in an engaged configuration, a central longitudinal axis of the gland 104 may not be coincident with, and may be angularly displaced from, a central longitudinal axis of the grip ring 116. In such embodiments, the portion of the ball and socket joint may allow the system 100 to be in an engaged configuration, with the system 100 rigidly coupled to and sealed against the outer surface of the pipe 190, while a central longitudinal axis of the pipe 190 is not coincident with, and is angularly displaced from, a central longitudinal axis of the end cap 102.

As illustrated in FIGS. 7 and 8, the grip ring 116 has a first end surface that extends radially inward from the radially-outermost surface 128 to the radially-innermost surface 120 and that faces toward the annular gasket 122 and a second end surface that extends radially inward from the radially-outermost surface 128 to the radially-innermost surface 120 and that faces away from the annular gasket 120. As also illustrated in FIGS. 7 and 8, the gasket 122 may be located directly radially inward of the end cap 102 and its flange 114, such that an outer surface of the gasket 122 is directly physically engaged with the inner surface 124 of the end cap 102. The gasket 122 may also have an inner surface configured to engage with the outer surface of the pipe 190 and an end surface that extends from its outer surface to its inner surface and that faces toward the grip ring 116.

As shown in FIGS. 7 and 8, continued threading of the nuts 108 onto the bolts 106 forces the gland 104 to move axially toward the flange 114 of the end cap 102, which, given the contours of the inner surface 126 of the gland 104 and the outer surface 128 of the grip ring 116, and the direct physical engagement of these surfaces, forces the grip ring 116 to move axially toward the end cap 102, as well as to contract radially inward toward the outer surface of the pipe 190. Because the grip ring 116 has an overall ring, hoop, or annular shape, where such shape is interrupted by the slot 118, a size of the slot 118 can decrease and ends of the grip ring 116 adjacent to the slot 118 can approach one another, as the grip ring 116 contracts radially in response to continued threading of the nuts 108 onto the bolts 106.

As the grip ring 116 moves axially toward the end cap 102, direct physical engagement of the first end surface of the grip ring 116 with the end surface of the gasket 122 (or indirect physical engagement of the first end surface of the grip ring 116 with the end surface of the gasket 122 through a spacer ring positioned between the annular gasket 122 and the grip ring 116) forces the gasket 122 to move axially into the end cap 102 and toward the first end 112 thereof. As the gasket 122 is forced in this direction, pressure between the outer surface of the gasket 122 and the inner surface 124 of the end cap 102 increases, and pressure between the inner surface of the gasket 122 and the outer surface of the pipe 190 increases, improving engagement between these surfaces and creating a seal between the inner surface 124 of the end cap 102 and the outer surface of the pipe 190.

As the grip ring 116 contracts radially inward toward the outer surface of the pipe 190, the inner surface 120 of the grip ring 116 eventually comes into direct physical contact with the outer surface of the pipe 190, and the teeth at the inner surface 120 of the grip ring 116 may bite into the outer surface of the pipe 190. Such engagement can prevent further contraction of the grip ring 116, and can also create a secure, rigid connection between the grip ring 116, and the system 100 as a whole, and the pipe 190. Such a connection can prevent or resist the pipe 190 being pulled out of the end cap 102. Thus, the system 100 may be in an engaged configuration and actuation of the system 100 may be considered complete.

In some embodiments, the system 100 can be released from the pipe 190 by simply unthreading the nuts 108 from the bolts 106. In particular, unthreading the nuts 108 from the bolts 106 can allow the gland 104 to be moved away from the end cap 102, which can allow the grip ring 116 to be released from the pipe 190 and the gasket 122, and can allow the gasket 122 to be removed from the pipe 190 and the end cap 102. Thus, the system 100 can be removed from the pipe 190 after installation in a simple manner, by hand, or with simple hand tools (e.g., a standard wrench).

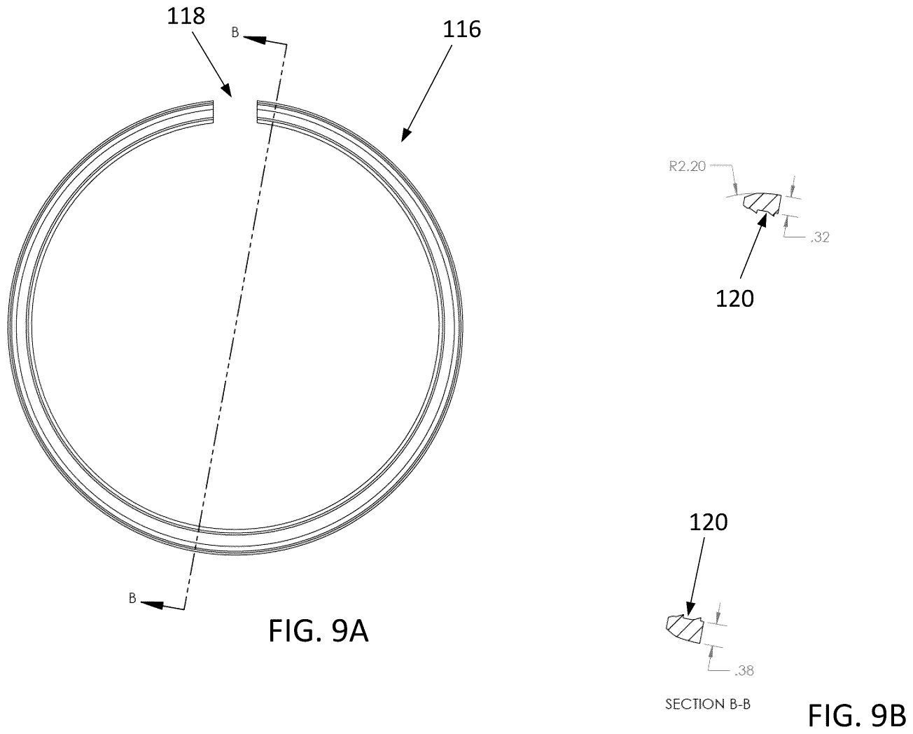

FIG. 9A illustrates an end view of the grip ring 116. FIG. 9B illustrates a cross-sectional view of the grip ring 116 taken along line B-B in FIG. 9A. As illustrated in FIG. 9B, a cross-sectional profile of the grip ring 116 may be variable along its length from a first end adjacent a first side of the slot 118 to a second end adjacent a second side of the slot 118. In particular, the cross-sectional area of the grip ring 116 may be smallest at its ends adjacent to the slot 118, and largest at a location in the middle of its length, that is, opposite to the slot 118 as illustrated in FIGS. 9A and 9B. In some embodiments, the cross-sectional area of the grip ring 116 may increase continuously and/or linearly with distance from the ends of the grip ring 116 adjacent the slot 118 to the location at the middle of its length. In other embodiments, the cross-sectional area of the grip ring 116 may increase in steps rather than continuously. As illustrated in FIG. 9B, the cross-sectional shape of the grip ring 116 may remain unchanged or substantially unchanged along its length except that a radial dimension thereof may increase from a minimum of 0.32 inches at each of its ends to a maximum of 0.38 inches at the middle of its length. That is, a radial dimension of the grip ring 116 may increase by a factor of 0.38/0.32 or about 1.1875, or between 1.1 and 1.25.

The variability of the cross-section of the grip ring 116 may increase uniformity of deformations (e.g., bending) in the grip ring 116 when the grip ring 116 is deformed (e.g., bent) such that the first end of the grip ring 116 moves toward the second end of the grip ring 116 and the size of the slot 118 decreases. The variability of the cross-section of the grip ring 116 may also increase a roundness of the grip ring 116 when the grip ring 116 is deformed such that the first end of the grip ring 116 moves toward the second end of the grip ring 116 and the size of the slot 118 decreases. Further, when the grip ring 116 is deformed such that the first end of the grip ring moves toward the second end of the grip ring 116 and the size of the slot 118 decreases, the variability of the cross-section of the grip ring 116 may control (e.g., increase) a degree of compression of the annular gasket 122 prior to the pipe-gripping teeth biting into a surface of the pipe 190, thereby improving engagement of the annular gasket 122 with the surface of the pipe 190 when the system 100 is in its engaged configuration. Further still, when the grip ring 116 is deformed such that the first end of the grip ring 116 moves toward the second end of the grip ring 116 and the size of the slot 118 decreases, the variability of the cross-section of the grip ring 116 may increase a uniformity of compression of the annular gasket 122 prior to the pipe-gripping teeth biting into a surface of the pipe 190, thereby improving engagement of the annular gasket 122 with the surface of the pipe 190 when the system 100 is in its engaged configuration.

As used herein, terms such as “increase” and “improve” carry their ordinary meaning unless the context clearly dictates otherwise. That is, in some cases, an increased uniformity, roundness, degree of compression, etc., means that the uniformity, roundness, degree of compression, etc., is higher than would be the case without the technologies and features described herein. Similarly, in some cases, an improved engagement means that the engagement is greater than would be the case without the technologies and features described herein.

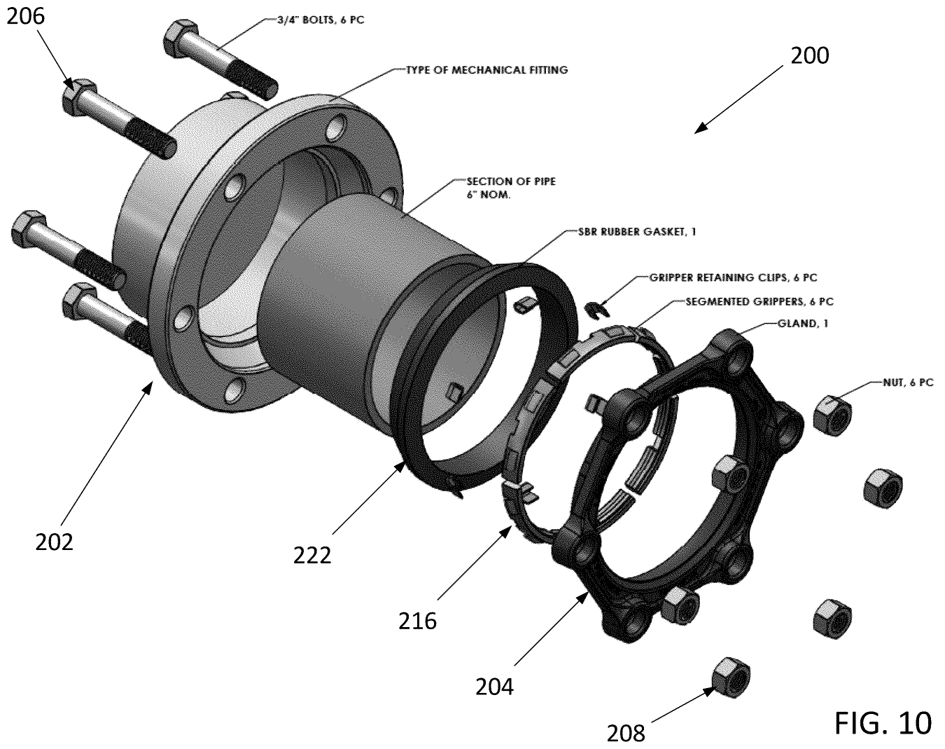

FIG. 10 illustrates another system 200 for capping an end of a pipe. As illustrated in FIG. 10, the system 200 includes an end cap 202, a gland 204, a gasket 222, and a plurality of bolts 206 and respective nuts 208 that couple the end cap 202 to the gland 204. The end cap 202, gland 204, gasket 222, and bolts 206 and nuts 208 can be the same as those described herein for system 100. As also illustrated in FIG. 10, the system 200 includes a grip ring assembly 216, which can function in many of the same ways described herein for grip ring 116, but which has a different structure than the grip ring 116, as described further elsewhere herein. Except as specifically described herein, the system 200 can have the same features, and can function and be used in the same way, as the system 100.

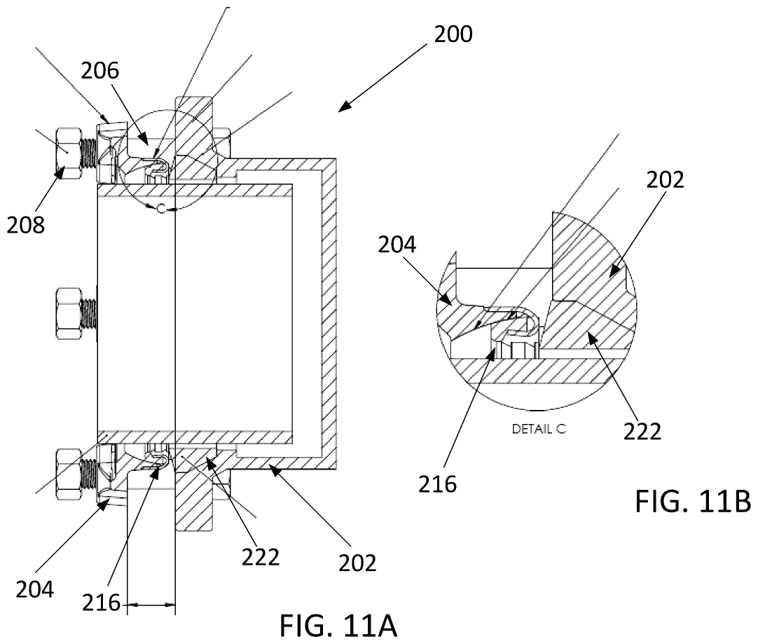

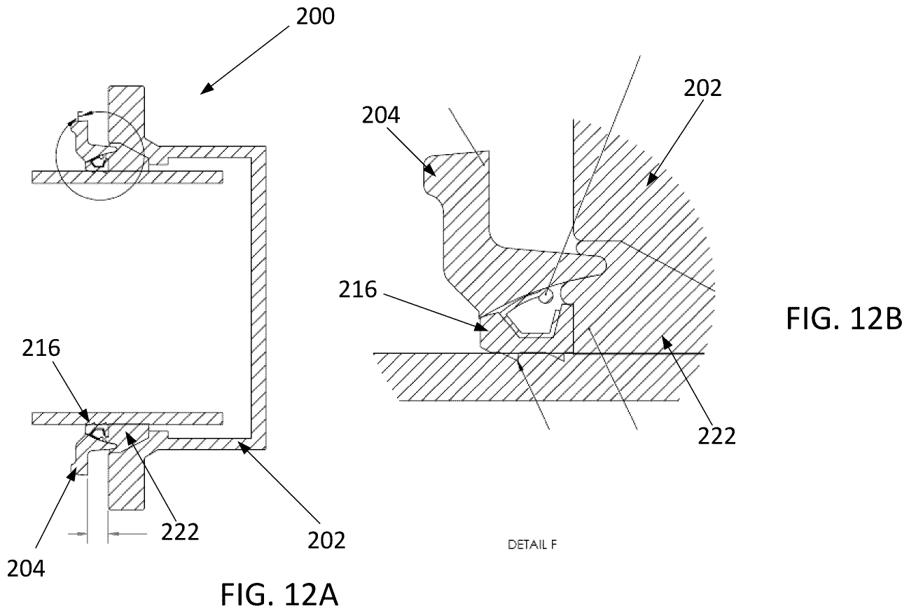

As further illustrated in FIG. 10, the grip ring assembly 216 can include a plurality of distinct grip ring segments separated from one another by slots that interrupt an otherwise annular shape of the grip ring assembly 216. In the embodiment illustrated in FIG. 10, the grip ring assembly 216 includes six distinct grip ring segments and six respective slots, but in alternative embodiments, the grip ring assembly 216 may include any number (e.g., three, four, five, eight, ten, twelve, etc.) of distinct grip ring segments and respective slots. FIG. 11A illustrates a cross-sectional view of the system 200 in a released configuration, FIG. 11B illustrates a portion of FIG. 11A at a larger scale, FIG. 12A illustrates a cross-sectional view of the system 200 in an engaged configuration, and FIG. 12B illustrates a portion of FIG. 12A at a larger scale.

As illustrated in FIGS. 10, 11A, 11B, 12A, and 12B, the grip ring assembly 216 can also include a plurality of retention clips configured to mechanically couple the distinct grip ring segments to the gland 204. In the embodiment illustrated in FIG. 10, the system 200 includes two retention clips for each distinct grip ring segment, but in alternative embodiments, the system 200 may include any number (e.g., one, three, four, five, etc.) of retention clips for each distinct grip ring segment. In use, the retention clips can ensure proper positioning of the distinct grip ring segments as the components of the system 200 are moved and actuated to engage an outer surface of a pipe.

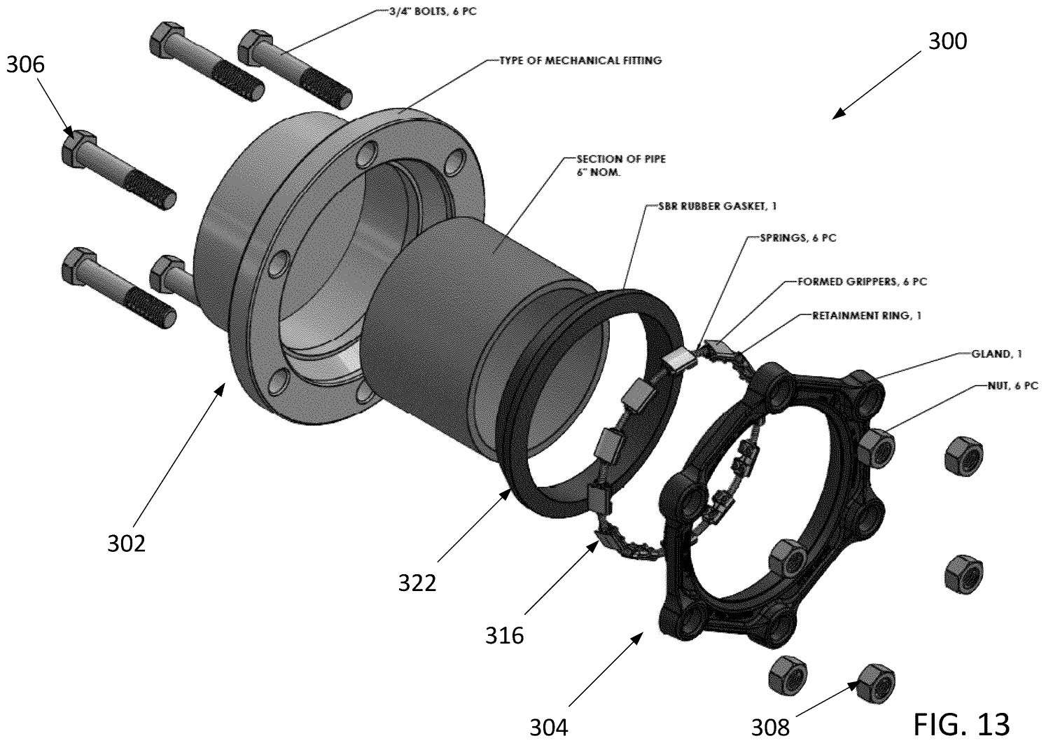

FIG. 13 illustrates another system 300 for capping an end of a pipe. As illustrated in FIG. 13, the system 300 includes an end cap 302, a gland 304, a gasket 322, and a plurality of bolts 306 and respective nuts 308 that couple the end cap 302 to the gland 304. The end cap 302, gland 304, gasket 322, and bolts 306 and nuts 308 can be the same as those described herein for system 100 and/or 200. As also illustrated in FIG. 13, the system 300 includes a grip ring assembly 316, which can function in many of the same ways described herein for grip ring 116 and/or the grip ring assembly 216, but which has a different structure than the grip ring 116 and the grip ring assembly 216, as described further elsewhere herein. Except as specifically described herein, the system 300 can have the same features, and can function and be used in the same way, as the system 100 and/or 200.

As further illustrated in FIG. 13, the grip ring assembly 316 can include a plurality of distinct grip ring segments separated from one another by slots that interrupt an otherwise annular shape of the grip ring assembly 316. In the embodiment illustrated in FIG. 13, the grip ring assembly 316 includes twelve distinct grip ring segments and twelve respective slots, but in alternative embodiments, the grip ring assembly 316 may include any number (e.g., three, four, five, six, eight, ten, etc.) of distinct grip ring segments and respective slots. FIG. 13 also illustrates that the grip ring assembly 316 includes an annular retention ring that extends through each of the distinct grip ring segments, and a plurality of springs located in each of the slots, which couple adjacent ones of the distinct grip ring segments to one another.

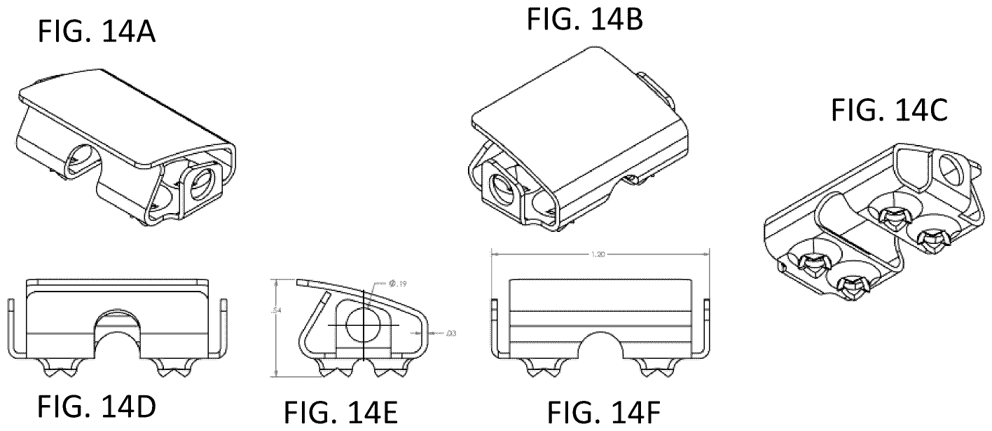

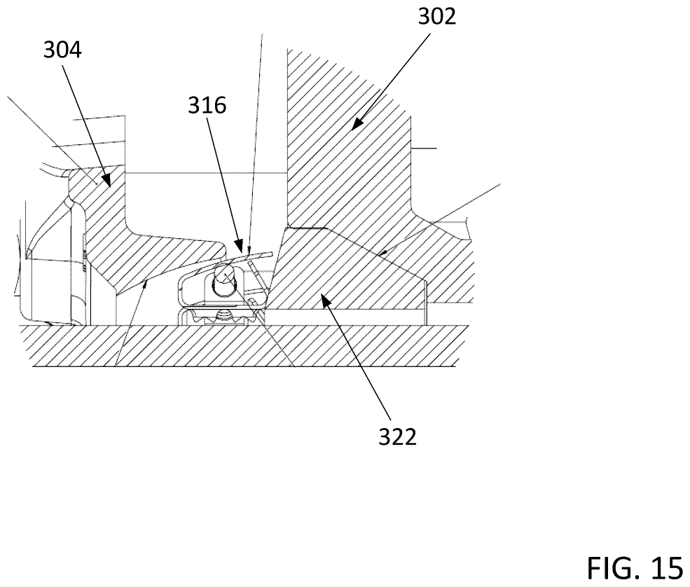

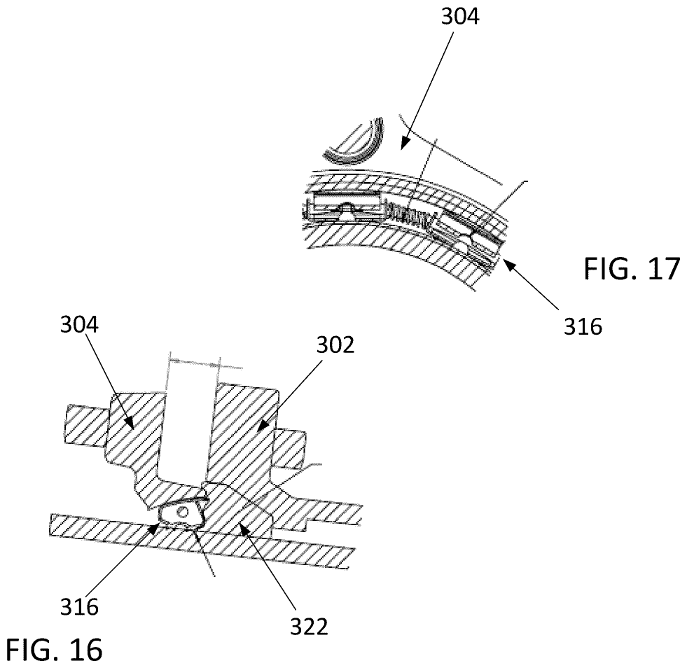

FIGS. 14A-14F illustrate different views of a single one of the distinct grip ring segments of the grip ring assembly 316. As illustrated in FIGS. 14A-14F, the distinct grip ring segments each include a radially innermost surface including a plurality of gripping teeth, as well as first and second side walls that include apertures to allow the annular retention ring to extend therethrough. FIG. 15 illustrates a cross-sectional view of the system 300 in a released configuration and FIG. 16 illustrates a cross-sectional view of the system 300 in an engaged configuration. As illustrated in FIGS. 15 and 16, in use, the annular retention ring can ensure proper positioning of the distinct grip ring segments as the components of the system 300 are moved and actuated to engage an outer surface of a pipe.

FIG. 17 shows a partial end view of the system 300. As illustrated in FIG. 17, the grip ring assembly 316 includes the springs which couple adjacent grip ring segments to one another, and which further assist in ensuring proper positioning of the distinct grip ring segments as the components of the system 300 are moved and actuated to engage an outer surface of a pipe. For example, the springs can help to ensure proper spacing between the distinct grip ring segments, such as by ensuring that they are equally spaced apart from one another.

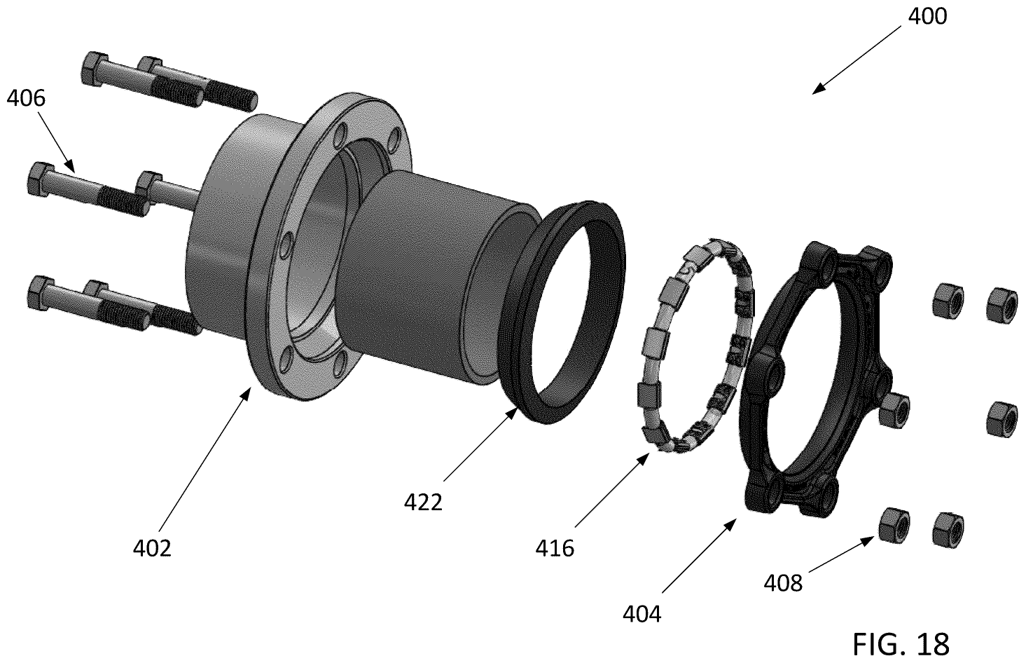

FIG. 18 illustrates another system 400 for capping an end of a pipe. As illustrated in FIG. 18, the system 400 includes an end cap 402, a gland 404, a gasket 422, and a plurality of bolts 406 and respective nuts 408 that couple the end cap 402 to the gland 404. The end cap 402, gland 404, gasket 422, and bolts 406 and nuts 408 can be the same as those described herein for system 100, 200, and/or 300. As also illustrated in FIG. 18, the system 400 includes a grip ring assembly 416, which can function in many of the same ways described herein for grip ring 116, grip ring assembly 216, and/or grip ring assembly 316, but which has a different structure than the grip ring 116, the grip ring assembly 216, and the grip ring assembly 316, as described further elsewhere herein. Except as specifically described herein, the system 400 can have the same features, and can function and be used in the same way, as the system 100, 200, and/or 300.

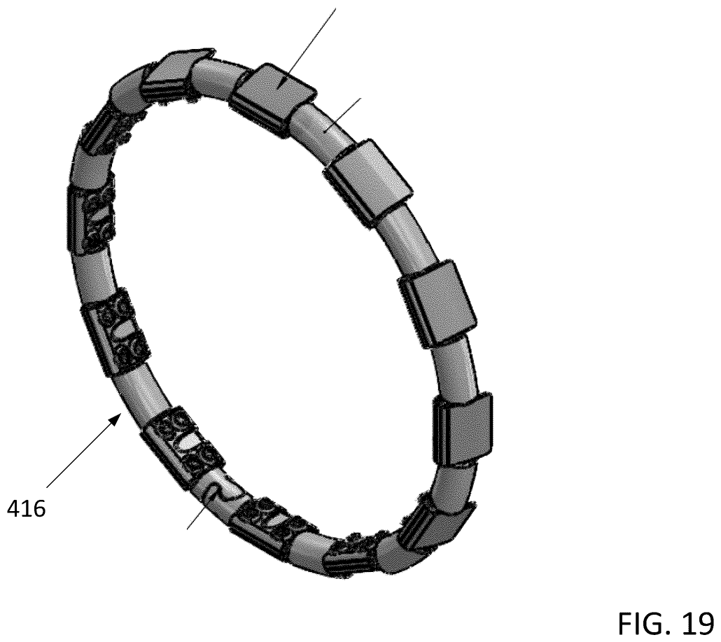

As further illustrated in FIG. 18, the grip ring assembly 416 can include a plurality of distinct grip ring segments separated from one another by slots that interrupt an otherwise annular shape of the grip ring assembly 416. In the embodiment illustrated in FIG. 18, the grip ring assembly 416 includes twelve distinct grip ring segments and twelve respective slots, but in alternative embodiments, the grip ring assembly 416 may include any number (e.g., three, four, five, six, eight, ten, etc.) of distinct grip ring segments and respective slots. FIG. 18 also illustrates that the grip ring assembly 416 includes an annular retention ring that extends through each of the distinct grip ring segments and which couples adjacent ones of the distinct grip ring segments to one another and which can ensure proper positioning of the distinct grip ring segments as the components of the system 400 are moved and actuated to engage an outer surface of a pipe. For example, the annular retention ring can help to ensure proper spacing between the distinct grip ring segments, such as by ensuring that they are equally spaced apart from one another. FIG. 19 shows the grip ring assembly 416 by itself. As illustrated in FIG. 19, the grip ring assembly 416 includes the annular retention ring, which may be a soft-durometer O-ring, and which may have two ends that are coupled to one another by a puzzle-cut connection.

In some embodiments, the springs and/or retention rings described herein for systems 300 and/or 400 may form spacers that fill slots between adjacent grip ring segments, which may integrally or monolithically include, or carry as a separate component, pipe-gripping teeth. These spacers may fill the slots, couple the grip ring segments to one another, and maintain alignment of the grip ring segments. These spacers may further have an elastic modulus configured to improve engagement of the annular gaskets 322 and/or 422 with a radially-outward facing surface of a pipe prior to the pipe-gripping teeth biting into the radially-outward facing surface of the pipe when the grip ring assembly 316 and/or 416 is deformed such that sizes of the slots decrease. The spacers (e.g., the springs and/or retention rings) may be elastomeric and/or metallic, and may, in use, undergo either only elastic deformations or elastic and plastic deformations.

In another embodiment, multiple systems similar to those described herein (e.g., similar to system 100) can be provided as a kit. For example, such a kit may include a first pipe joint system as described herein for system 100, having a first grip ring, where the annular shape of the first grip ring has a first inner diameter and a first cross-sectional profile, and a second pipe joint system as described herein for system 100, having a second grip ring, where the annular shape of the second grip ring has a second inner diameter larger than the first inner diameter and a second cross-sectional profile, where the second cross-sectional profile is larger than the first cross-sectional profile.

In such a kit, a cross-sectional area of the first grip ring at the first end of the first grip ring may be smaller than a cross-sectional area of the second grip ring at the first end of the second grip ring, a cross-sectional area of the first grip ring at the second end of the first grip ring may be smaller than a cross-sectional area of the second grip ring at the second end of the second grip ring, and a cross-sectional area of the first grip ring at a mid-point of the first grip ring may be smaller than a cross-sectional area of the second grip ring at a mid-point of the second grip ring. Further, the first cross-sectional profile may have a first overall length in a direction parallel to a central longitudinal axis of the first pipe joint system and the second cross-sectional profile may have a second overall length in a direction parallel to a central longitudinal axis of the second pipe joint system, where the second overall length is longer than the first overall length.

In such a kit, the first and second cross-sectional profiles of the first and second grip rings may be configured to ensure that behavior of the first grip ring when the first grip ring is deformed such that the first end of the first grip ring moves toward the second end of the first grip ring matches behavior of the second grip ring when the second grip ring is deformed such that the first end of the second grip ring moves toward the second end of the second grip ring.

In another embodiment, multiple systems similar to those described herein (e.g., similar to system 100) can be provided as a kit. For example, such a kit may include a first pipe joint system as described herein for system 100, having a first grip ring, where the annular shape of the first grip ring has a first inner diameter and a radially-outermost surface that extends at a first oblique angle to a radially-innermost surface, and a second pipe joint system as described herein for system 100, having a second grip ring, where the annular shape of the second grip ring has a second inner diameter larger than the first inner diameter and a radially-outermost surface that extends at a second oblique angle to a radially-innermost surface, where the second oblique angle is different than the first oblique angle.

The first and second oblique angles may be configured to ensure that behavior of the first grip ring when the first grip ring is deformed such that the first end of the first grip ring moves toward the second end of the first grip ring matches behavior of the second grip ring when the second grip ring is deformed such that the first end of the second grip ring moves toward the second end of the second grip ring.

While the systems described herein are described as including an end cap, and coupling the end cap to a pipe, in alternative embodiments the systems described herein can be used to couple any pipe fittings or other related components, rather than an end cap, to a pipe. Such alternative pipe fittings and related components may include another pipe, a pipe valve, etc.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A system, comprising:
an annular gasket;
a grip ring including:
a slot that interrupts an otherwise annular shape of the grip ring such that the grip ring has a first end adjacent a first side of the slot and a second end adjacent a second side of the slot opposite to the first side of the slot;
a radially-innermost surface having circumferential pipe-gripping teeth;
a radially-outermost surface;
a first end surface that extends radially inward from the radially-outermost surface to the radially-innermost surface and that faces toward the annular gasket; and
a second end surface that extends radially inward from the radially-outermost surface to the radially-innermost surface and that faces away from the annular gasket;
wherein a cross-sectional area of the grip ring increases from a first local minimum at the first end of the grip ring to a maximum at a location between the first end of the grip ring and the second end of the grip ring along the annular shape of the grip ring and from a second local minimum at the second end of the grip ring to the maximum at the location between the first end of the grip ring and the second end of the grip ring along the annular shape of the grip ring; and
an annular gland including an inner surface that faces toward the radially-outermost surface of the grip ring.

2. (canceled)

3. The system of claim 1 wherein the cross-sectional area of the grip ring increases in steps from the first local minimum to the maximum and from the second local minimum to the maximum.

4-5. (canceled)

6. The system of claim 1 wherein, when the grip ring is deformed such that the first end of the grip ring moves toward the second end of the grip ring, the increasing of the cross-sectional area of the grip ring increases a degree of compression of the annular gasket prior to the pipe-gripping teeth biting into a surface of a pipe, thereby improving engagement of the annular gasket with the surface of the pipe.

7. (canceled)

8. The system of claim 1 wherein the first end surface of the grip ring directly contacts the gasket.

9-11. (canceled)

12. The system of claim 1 wherein the radially-outermost surface of the grip ring forms at least a portion of a surface of a ball of a ball-and-socket joint and the inner surface of the annular gland forms at least a portion of a surface of a socket of the ball-and-socket joint.

13-16. (canceled)

17. A system, comprising:
an annular gasket;
a grip ring assembly including:
a plurality of distinct grip ring segments separated from one another by slots that interrupt an otherwise annular shape of the grip ring assembly;
a spacer that fills the slots, couples the grip ring segments to one another, and maintains alignment of the grip ring segments;
a radially-innermost surface having circumferential pipe-gripping teeth;
a radially-outermost surface;
a first end surface that extends radially inward from the radially-outermost surface to the radially-innermost surface and that faces toward the annular gasket; and
a second end surface that extends radially inward from the radially-outermost surface to the radially-innermost surface and that faces away from the annular gasket;
wherein the spacer has an elastic modulus configured to improve engagement of the annular gasket with a radially-outward facing surface of a pipe prior to the pipe-gripping teeth biting into the radially-outward facing surface of the pipe when the grip ring assembly is deformed such that sizes of the slots decrease; and
an annular gland including an inner surface that faces toward the radially-outermost surface of the grip ring assembly.

18. The system of claim 17 wherein the spacer is an elastomeric spacer.

19. The system of claim 17 wherein the spacer is a metallic spacer.

20-21. (canceled)

22. The system of claim 17 wherein, when the grip ring assembly is deformed such that sizes of the slots decrease, the elastic modulus of the spacer controls a degree of compression of the annular gasket prior to the pipe-gripping teeth biting into the radially-outward facing surface of the pipe.

23-24. (canceled)

25. The system of claim 17 wherein the pipe-gripping teeth are not integral with the plurality of distinct grip ring segments.

26. (canceled)

27. The system of claim 17, wherein the pipe is a first pipe and the annular gasket is engaged with the radially-outward facing surface of the first pipe and with an at least partially longitudinally-facing surface of a second pipe to create a seal between the first pipe and the second pipe at a joint between the first and second pipes, wherein the second pipe is a component of a pipe fitting.

28. The system of claim 17, wherein the pipe is a first pipe and the annular gasket is engaged with the radially-outward facing surface of the first pipe and with an at least partially longitudinally-facing surface of a second pipe to create a seal between the first pipe and the second pipe at a joint between the first and second pipes, wherein the second pipe is a component of a pipe valve.

29. The system of claim 17, wherein the pipe is a first pipe and the annular gasket is engaged with the radially-outward facing surface of the first pipe and with an at least partially longitudinally-facing surface of a second pipe to create a seal between the first pipe and the second pipe at a joint between the first and second pipes, wherein the pipe-gripping teeth engage the radially-outward facing surface of the first pipe to resist longitudinal movement of the first pipe with respect to the grip ring assembly.

30. (canceled)

31. The system of claim 29 wherein the distinct grip ring segments are accessible by a human operator from outside the joint.

32. The system of claim 29 wherein, when the annular gland is removed from the joint between the first pipe and the second pipe, the pipe-gripping teeth disengage from the radially-outward facing surface of the first pipe and cease resisting longitudinal movement of the first pipe with respect to the grip ring assembly.

33. The system of claim 17 wherein a cross-sectional shape of each of the distinct grip ring segments of the grip ring assembly is convex at a radially-outermost surface of the grip ring segment and a cross-sectional shape of the annular gland is concave at the inner surface of the annular gland.

34-37. (canceled)

38. The system of claim 17, further comprising a spacer ring between the annular gasket and the grip ring.

39-44. (canceled)

45. A system, comprising:
an annular gasket;
a grip ring including:
a radially-innermost surface having circumferential pipe-gripping teeth;
a radially-outermost surface;
a first end surface that extends radially inward from the radially-outermost surface to the radially-innermost surface and that faces toward the annular gasket; and
a second end surface that extends radially inward from the radially-outermost surface to the radially-innermost surface and that faces away from the annular gasket;
wherein a cross-sectional shape of the grip ring is convex at the radially-outermost surface of the grip ring; and
an annular gland including an inner surface that faces toward the radially-outermost surface of the grip ring.

46. (canceled)

47. The system of claim 45 wherein a cross-sectional shape of the annular gland is linear at the inner surface of the annular gland.

48. The system of claim 45 wherein the radially-outermost surface of the grip ring forms at least a portion of a surface of a ball of a ball-and-socket joint and the inner surface of the annular gland forms at least a portion of a surface of a socket of the ball-and-socket joint.

49-52. (canceled)
